(19) United States
(12) Patent Application Publication
(10) Pub. No.: US 2007/0009403 A1
(43) Pub. Date: Jan. 11, 2007

(54) Microphotoreactor for carrying out photochemical reactions

(75) Inventors: Wolfgang Ehrfeld, Mainz (DE); Frank Schael, Landwehrstrabe (DE)

Correspondence Address: NORRIS, MCLAUGHLIN & MARCUS, P.A., 875 THIRD AVE, 18TH FLOOR, NEW YORK, NY, 10022, US

(73) Assignee: EHRFELD MIKROTECHNIK BTS GMBH, WENDELSHEIM (DE)

(21) Appl. No.: 10/569,991

(22) PCT Filed: Aug. 19, 2004
(86) PCT No.: PCT/EP04/09307

§ 371 Date: Feb. 28, 2006

(30) Foreign Application Priority Data
Sep. 5, 2003 (DE) 103 41 500.9

(51) Int. Cl. B01J 19/08

(52) U.S. Cl. 422/186

(57) ABSTRACT

Microphotoreactor for photochemical reactions, with a radiation source located outside the reactor and reaction channels inclined at an angle of 10°-90° from horizontal so that the reaction mixture is transported in the reaction channels by a pressure differential counter to gravity.

The invention relates to a microphotoreactor for carrying out photochemical reactions in at least one reaction medium which is liquid, gaseous or a dispersion.

Photochemical reactions are used, inter alia, for the technical synthesis of chemical compounds, e.g. in the fields of pharmaceuticals, plant protection agents, odorants and vitamins. Such reactions are currently carried out above all in large-scale reactors. One problem with the latter is that of uniformly irradiating the reactants with light in order to carry out the reactions. DE 101 05 427 A1 describes a photochemical reactor in which hollow glass or quartz bodies filled with gas are present in the medium to be reacted. The gas in the hollow bodies is excited by an external electromagnetic field so that light is formed directly in the medium.

To avoid the formation of a light-absorbing layer on the surface of the lamp cooler, DE 36 25 006 A1 describes a photoreactor for photochemical syntheses which comprises, from the inside outwards, a concentrically arranged lamp with electrical connections, an annular lamp cooler made of glass and a reaction chamber which is bounded by the external jacket of the lamp cooler and the internal jacket of the reactor having a mirrored internal wall, wherein a device fitted with brushes or wipers rotates in the reaction chamber, said device being arranged in such a manner that the external jacket of the lamp cooler is kept free from a light-absorbing layer during the operation of the photoreactor.

In contrast to the conventional reactors, microreactors can provide a more favourable surface-to-volume ratio. This surface-to-volume ratio can also be utilized to considerably improve the transport of radiation in a reaction solution compared with conventional photochemical apparatuses. The ratios in conventional units for photochemical reactions frequently mean that only small concentrations of starting products can be used. This is partially due to the fact that the thickness of the irradiated layer of liquid cannot be effectively controlled.

In H. Ehrlich el al., Application of Microstructured Reactor Technology for the Photochemical Chlorination of Alkylaromatics, Chimia 56 (2002), pp. 647 to 653, the use of a micro-falling film reactor is described for the selective photochlorination of toluene-2,4-diisocyanate. A corresponding micro-falling-film reactor is also described in DE 101 62 801 A1. Although this reactor allows the entry of radiation through a window, it does not make use of the complete quantity of incident light, since a portion of the latter is obscured due to the reactor design. In addition, this reactor has the disadvantage that the residence and irradiation times cannot be controlled over a wide range since the falling-film principle always involves at least a latent risk that the film will break.

An additional microreactor for photochemical reactions is described by Hang Lu et al., Photochemical reactions and on-line UV detection in microfabricated reactors, Lab on a chip, 2001, 1, pp. 22 to 28. In this microreactor a silicon chip is provided with a channel. The reactor is covered with a pyrex panel to allow irradiation with light. The disadvantage of the microreactor disclosed in this reference is that the residence behaviour of the reactants in the channel is not very well defined and the reactor design comprising a single channel does not allow effective adjustment of the flow rates and irradiation times. In addition, silicon, i.e. the material used for the reactor described by Hang Lu et al. is brittle and thus susceptible to breakage, difficult to clean and not compatible for many media.

The problem on which the present invention was based was therefore that of providing a microphotoreactor which has a specific residence behaviour of the reactants in the reaction chambers and allows the adjustment of the flow rates and irradiation times.

The solution according to the invention consists of a microphotoreactor for carrying out photochemical reactions in at least one reaction medium which is liquid, gaseous or a dispersion and in which the light required for carrying out the reaction is supplied by an irradiation source arranged outside the reactor. In this microphotoreactor the reaction medium flows through at least one reaction channel in a reaction zone, wherein at least one region of this zone is transparent to the light, and the inclination of the direction of flow towards the horizontal And the arrangement of the inlet and outlet of the at least one reaction channel are such that the reaction medium is conveyed counter-gravitationally in the at least one reaction channel by a pressure difference.

The angle at which the direction of flow is inclined towards the horizontal is preferably in the range from 10° to 90°, whereby resistance to flow is produced in the reaction channels which is greater than the fringe effects occurring inside the individual reaction channels. This produces a narrow residence time distribution in the reaction channels. The angle of inclination of the direction of flow towards the horizontal is dependent on the viscosity of the reaction medium. As the viscosity increases, a lower angle can be selected, since the resistance to flow also increases as the viscosity increases.

In a preferred embodiment of the invention, the reaction zone has the shape of a panel which contains the at least one reaction channel and whose at least one panel surface is transparent. Such a reaction zone panel can also be designed in such a manner that the reaction channels are only contained in one panel part which is then covered with a transparent panel part, although the reverse arrangement is also possible.

The direction of flow is determined by the inclination of the reaction zone.

A decisive proportion of the total residence time of the reaction medium in the apparatus consists in the time during which it passes through the irradiated zone and can be photochemically reacted. The irradiation time which is necessary to convert a specific number of moles of a compound, can be estimated by the following equation:

$$t = n \frac{{hcN}_{L}}{I λϕ} \qquad ( 1 )$$

t is the irradiation time (in s), I is the radiant power (in watts), h is Planck's constant (in J), c is the light velocity (in m/s), λ is the wavelength (in m), N_{L} is Avogrado's number (in mol⁻¹), n is the mole number of the irradiated molecules and φ is the quantum yield of the reaction.

The above equation shows that the irradiation time is essentially dependent on the quantum yield, the intensity of the light source and the number of molecules to be reacted. The irradiation time of the microphotoreactor according to the invention can be adjusted to requirements by the adjustment of the flow rate by the pressure difference applied. The replacement of the reaction zone panel additionally allows adjustment to a required throughput.

In a preferred embodiment, the reaction zone contains 10 to 10,000 reaction channels. The reaction channels are preferably dimensioned according to the photochemical reaction to be carried out. The preferred depth and width dimensions of the reaction channels are in the range from 10 μm to 1000 μm.

The reaction channels are preferably produced with the aid of etching processes, laser medium processing, microspark erosion or other microproduction processes. The depth of the reaction channels is selected so that on the one hand sufficient irradiance is generated up to the channel rim to produce the required conversion rate even at the rim. On the other hand, a maximum quantity of radiation should be absorbed in the reaction medium in order to be able to use a maximum quantity of the ingoing energy for the reaction. The depth of penetration can be calculated with the aid of the Lambert-Beer law, i.e. as the thickness of the liquid layer above which the intensity of the incident radiation falls to 90% of the intensity of the original incident radiation.

$${d}_{90 \%} = \frac{1}{ɛ c} \qquad ( 2 )$$

In this equation, ε and c are the molar extinction coefficient (in L mol⁻¹ cm⁻¹) or the concentration (in mol/L). Alternatively, other depths of penetration (e.g. a reduction in the intensity to 1/e-th of the original intensity) can be set.

In a preferred embodiment, the reaction channels have a circular cross-section, thereby avoiding the adherence of compounds contained in the reaction medium to corners.

The microchannels can be designed in parallel arrangements with straight, angular, curved or other geometries known to the skilled man. In order to adjust the irradiation time the reaction channels can preferably cover a longer distance in the irradiated reaction zone at an identical flow rate.

In a further preferred embodiment the inlet to the reaction channels is designed to allow mixing of at least two components.

In a particularly preferred embodiment the reaction channels are coated, possible coatings to be used being those which have an effect on the surface tension of the reaction medium so as to influence the flow properties. Catalytically active coatings are particularly preferred which can have a favourable effect on the chemical reaction in the microphotoreactor. Coatings of a material having high reflectivity over the spectral range of the radiation employed are also possible.

It is not only possible for the reaction channels to be coated but also, in an additional preferred embodiment, for the lower panel layer to be made of a material which is catalytically active, which influences the surface tension of the reaction medium, or which has high reflectivity over the spectral range of the radiation employed.

In order to allow irradiation of the reaction medium, the reaction zone panel, in a preferred embodiment, comprises at least one lower panel part and a transparent top panel part which rests in a flush manner on the lower panel part.

In a preferred embodiment the radiation sources used are for example gas discharge lamps, semiconductor light sources or lasers which irradiate the reaction medium to be irradiated through the transparent top panel. It is possible for several irradiation sources which emit light at various wavelengths or in various spectral ranges to be used simultaneously. The radiation source preferably used for the photochemical reaction irradiates the reaction medium homogeneously and spectrum-selectively in the selected range.

The microphotoreactor can be flat, curved or cylindrical in shape. If it is curved or cylindrical the transparent panel part is preferably arranged on the inner side pointing to an irradiation source.

In a preferred embodiment the transparent panel part is thermally insulating. For this purpose it can be produced from a thermally insulating material or can preferably be double-walled with an air gap. This prevents fogging of the panel at low temperatures of the reaction medium. In an additional preferred embodiment the transparent panel part is designed in the form of a spectral filter which can be a short-pass, long-pass, band-pass or interference filter. Furthermore, the transparent panel part can contain an IR filter in order to prevent undesired heating of the reaction medium by infrared portions of the irradiation source.

In a preferred embodiment the reaction channels are formed in the lower panel part. In order to prevent any escape of the reaction medium from the reaction channels, the latter are covered by the transparent top panel. The transparent panel part can be smooth or also contain reaction channels formed therein. In a preferred embodiment the reaction channels are accommodated both in the lower panel part and in the transparent panel part and are superimposed congruently upon one another. This means that the cross-sectional geometry of the reaction channels is predetermined by the shape of the reaction channels in the lower panel part and the shape of the reaction channels in the transparent panel part.

In order to discharge the heat forming during the reaction or to supply additional heat, the reaction zone can be fixed detachably to a heat transfer module. In order to temper the reaction zone panel, the heat transfer module can comprise an electrical heating means or Peltier elements or can be in the form of a heat exchanger. Due to the inclusion of gaps between individual heating or cooling zones in the heat transfer module a temperature gradient can be adjusted in the reaction zone panel in the direction of flow. By means of sensors which are integrated either in the lower panel of the reaction zone panel or in the heat transfer module, the pressure, temperature, viscosity or flow rate can for example be predetermined. It is possible to use for this purpose, for example, pressure, temperature, heat conductivity, viscosity or radiation sensors and capacitive, inductive, piezoresistive or dielectric sensors or conductivity or ultrasound detectors.

In the following, the invention is described in additional detail by means of a drawing.

This shows in:

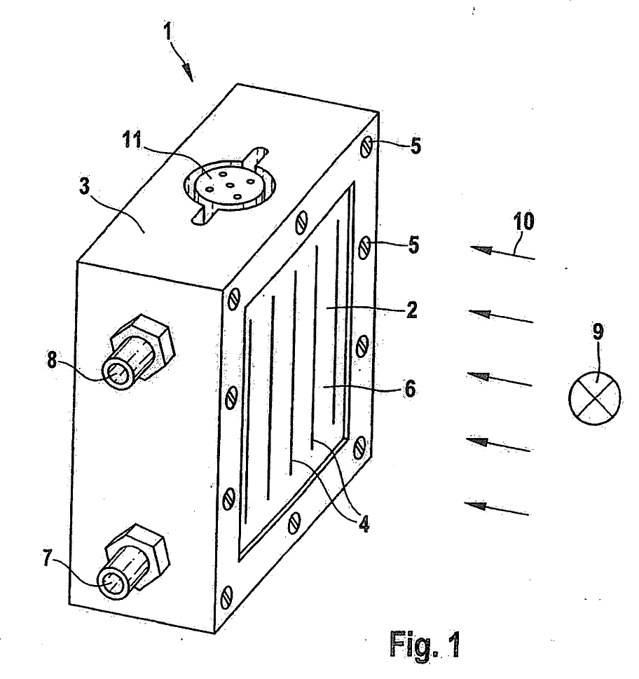

FIG. 1 a perspective view of a vertically positioned microphotoreactor with an irradiation device,

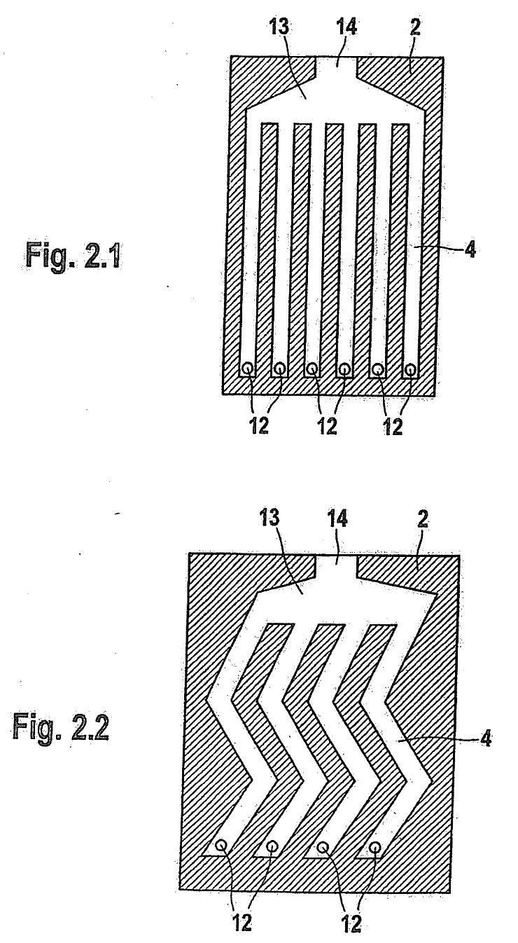

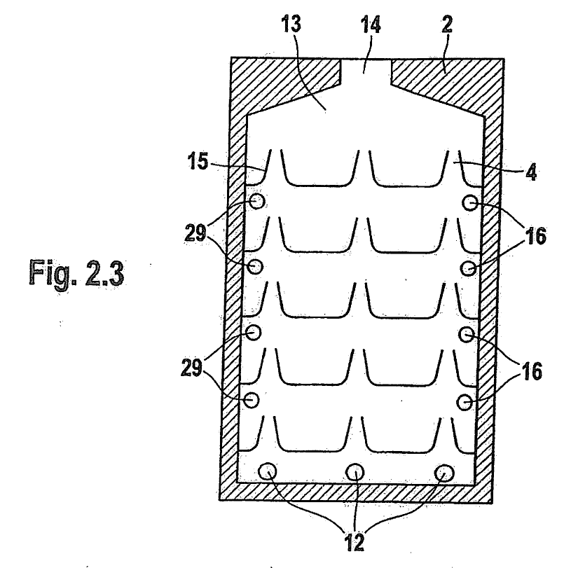

FIG. 2.1 a schematic depiction of a reaction zone panel with straight reaction channels,

FIG. 2.2 a schematic depiction of a reaction zone panel with angular reaction channels,

FIG. 2.3 a schematic depiction of a reaction zone panel with a channel with a structured wall,

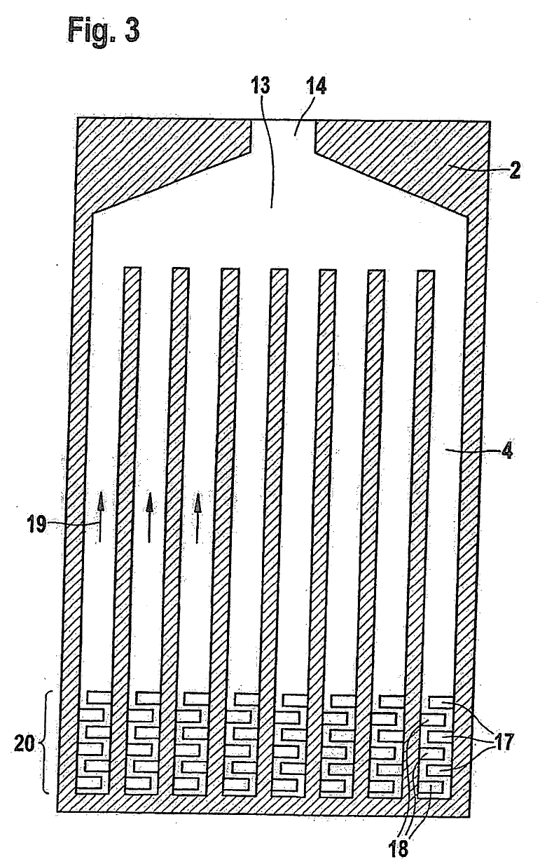

FIG. 3 a schematic depiction of a reaction zone panel with integrated mixing structures,

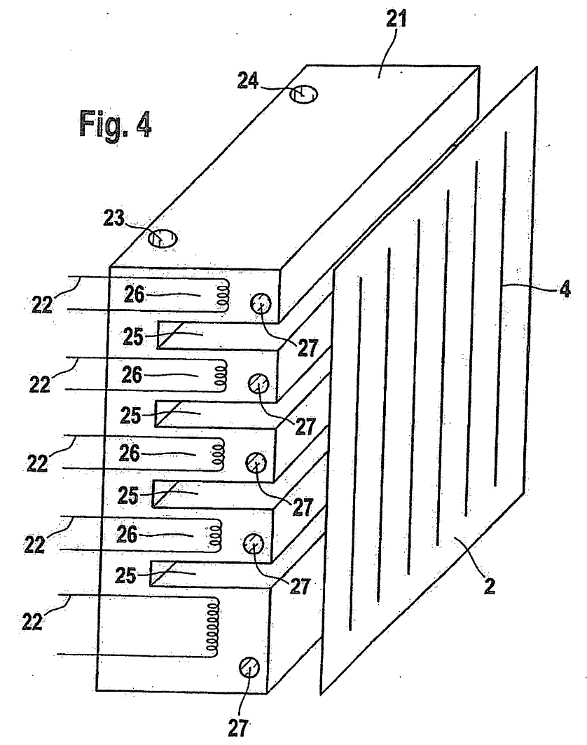

FIG. 4 a microphotoreactor with a heat transfer module and a reaction zone panel.

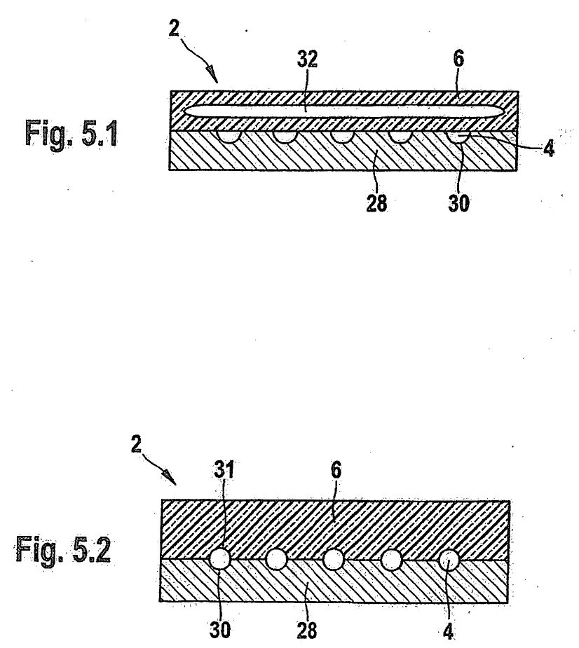

FIG. 5.1 a cross-section through a reaction zone panel in a first embodiment

FIG. 5.2 a cross-section through a reaction zone panel in a second embodiment

FIG. 1 shows a perspective view of a vertically positioned microphotoreactor with an irradiation source.

A microphotoreactor 1 comprises a reaction zone which is in the form of a reaction zone panel 2 and is accommodated in a housing 3. Reaction channels 4 in which the photochemical reaction takes place, are accommodated in the reaction zone panel 2. Depending on the size of the reaction zone panel 2 preferably between 10 and 10,000 reaction channels 4 can be accommodated in the reaction zone panel 2. In addition to the arrangement depicted in FIG. 1 with parallel, straight reaction channels 4 the reaction channels 4 can also be angular or curved or can be arranged in any other desired manner known to the skilled man.

The reaction zone panel 2 can be fixed in the housing 3 non-positively or positively. In the embodiment depicted in FIG. 1 the reaction zone panel 2 is fixed in the housing 3 non-positively with screws 5. The reaction zone panel 2 preferably comprises a lower panel part which is sealed with a transparent top panel part 6 which is transparent to light of the wavelength required for the reaction.

The reaction medium is supplied to the reaction zone panel 2 via an inlet 7. If the mixing of the reactants is only to take place in the reaction zone panel 2, each reactant must be provided with its own inlet 7.

The product obtained by the photochemical reaction is removed from the microphotoreactor 1 through an outlet 8. In order to increase the resistance to flow in addition to the resistance to flow imposed by gravity in the reaction channels 4, a valve can be arranged in the outlet 8. The reaction medium is transported in the reaction channels 4 by a pressure difference. The light required for the photochemical reaction is emitted by an irradiation source 9. Suitable irradiation sources are for example gas discharge lamps, semiconductor light sources or lasers. The irradiation source 9 is chosen in such a manner that light is irradiated in the wavelength range required for the photochemical reaction. The wavelength range of the light can range from the infrared range through the visible light range to the ultraviolet range. Preferably the irradiation source 9 is designed so that the emitted light falls on the reaction zone panel 2 in the direction labelled with reference numeral 10.

Sensors can be integrated in the microphotoreactor for monitoring pressure, temperature, viscosity and rate of flow. The voltage supply for the sensors, if such a supply is necessary, and the transmission of data then take place via an electrical connection 11 arranged on the housing 3. The data can be transmitted via cables, optical fibres or radio techniques to an external peripheral. The function of the peripheral is to register, display, process and regulate temperatures, pressures, flow rates, irradiation intensities or irradiation wavelengths. The irradiation intensities or irradiation wavelength are preferably measured on the basis of the measurement of conversion rates. Computers are preferably used as the external peripheral.

FIGS. 2.1, 2.2 and 2.3 show various embodiments of the reaction channels in the reaction zone panel.

In the embodiment depicted in FIG. 2.1 the reaction channels 4 are arranged in parallel and straight in the reaction zone panel 2. The reaction medium is supplied via inlet openings 12 in the lower region of the reaction channels 4. The reaction medium then flows upwards in the individual reaction channels 4, during which it is irradiated with light from the radiation source 9 not depicted in this figure. In the reaction channels 4 the reaction medium is then reacted to form the product. The product collects in a collection zone 13 arranged above the reaction channels 4. The product is removed from the collection zone 13 via an outlet 14.

By contrast, FIG. 2.2 shows an embodiment with angular reaction channels 4. Here as well the reaction medium is introduced into the reaction channels 4 via inlet openings 12. The photochemical reaction in which the reaction medium is converted into the product takes place in the reaction channels 4. The product collects in the collection zone 13 and is discharged from the collection zone 13 via outlet 14. As a result of the angular arrangement of the reaction channels 4, fewer reaction channels 4 can be accommodated on the reaction zone panel 2 than in the case of straight reaction channels. The flow path and thus the residence time in the microphotoreactor are prolonged as a result of the angular reaction channels 4.

FIG. 2.3 shows a further embodiment with a broad reaction channel 4 into which a structure 15 is impressed. In the design variant shown in FIG. 2.3 the reaction medium is also introduced via inlet openings 12 in the lower region of the reaction zone panel 2. In this variant the product is removed via outlet 14 which is arranged in the upper region of the reaction zone panel 2. In the embodiment depicted in FIG. 2.3, a collection zone 13 can be dispensed with, since the entire reaction medium is conveyed via one reaction channel 4. In addition, a further fluid can be supplied in the design variant depicted in FIG. 2.3 via openings 16, which are arranged on the side. As a result of structure 15 in reaction channel 4 the fluid added laterally via openings 16 mixes with the reaction medium introduced via inlet opening 12. As a result of the addition of the fluid via openings 16 a transverse stream is produced with which, for example, solid particles can be removed from the reaction medium. The transverse stream with the solid particles contained therein can then be removed from the channel via outlet openings 29.

FIG. 3 shows a reaction zone panel with integrated mixing structures.

The embodiment shown in FIG. 3 corresponds essentially to the embodiment shown in FIG. 2.1. In contrast to the embodiment shown in FIG. 2.1 the entry of the reaction medium into the reaction channels 4 does not take place via in each case one inlet opening 12, but via a mixing zone 20 in which a first fluid is supplied to the reaction channels 4 via inlet openings 17 for the first fluid and a second fluid is supplied to the reaction channels 4 via inlet openings 18 for the second fluid. In order to guarantee intense mixing of the first fluid and the second fluid, the inlet openings 17 and 18 are arranged in an alternating manner. In the design variant depicted in FIG. 3, the inlet openings 17 for the first fluid are in each case arranged on the righthand side of the reaction channel 4 and the inlet opening 18 for the second fluid on the lefthand side of the reaction channel 4. The inlet openings 17 for the first fluid are intermeshed with the inlet openings 18 for the second fluid, thus guaranteeing intense mixing of the two fluids. In the reaction channel 4 the reaction medium flows to the collection zone 13 in the direction of flow labelled with reference numeral 19. The product is then removed from the collection zone 13 via outlet 14. In addition to the alternately arranged intermeshed inlet openings 17 and 18, a profiled section can also be fitted in the reaction channel 4 for mixing the components of the reaction medium. The irradiation required for the photochemical reaction can then either occur in the region of the mixing zone 20 and/or in the region following the mixing zone 20.

FIG. 4 depicts a microphotoreactor with a heat transfer module and a reaction zone panel.

In order to be able to discharge heat formed during the photochemical reaction or supply additional heat, the reaction zone panel 2 can preferably be mounted detachably on a heat transfer module 21. In this design the heat can be supplied either via electrical heating elements 22 or via a tempering medium. Water or thermal oils are for example a suitable tempering medium. Via an inlet 23 for the tempering medium, the tempering medium is supplied to the heat transfer module and removed again via an outlet 24 for the tempering medium. In order to heat or cool the reaction zone panel 2 with a tempering medium, fluid channels are arranged in the heat transfer module 21, through which the tempering medium flows. By the arrangement of gaps 25 in the heat transfer module 21 which are arranged transversely to the direction of flow of the reaction medium in the reaction zone panel 2 the heat transfer module 21 can be subdivided into individual tempering regions 26. If the individual tempering regions 26 are are tempered differently this allows a temperature gradient to be produced in the reaction zone panel 2. In order to monitor the temperature of the individual tempering regions 26, temperature sensors 27 are preferably arranged in the tempering regions 26. Thermoelements or resistance thermometers are for example suitable as temperature sensors 27.

Since the reaction zone panel 2 is detachably attached to the heat transfer module 21 it is simple to replace the reaction zone panel 2 if other reaction conditions are required or a different reaction is to be carried out.

In order to increase the throughput it is simple to arrange several microphotoreactors 1 in parallel. The advantage of arranging individual microreactors 1 in parallel is that the reaction conditions do not change on increasing the reaction throughput.

In addition to the parallel arrangement of the reaction channels 4, the reaction channels 4 can also be arranged consecutively.

FIG. 5.1 depicts a cross-section through a reaction zone panel in a first embodiment.

The reaction zone panel 2 comprises a lower panel part 28 and a transparent top panel part 6. The lower panel part 28 is preferably produced from a material which favourably influences the surface tension of the reaction medium or has catalytic activity or has high reflectivity in the spectral range of the radiation employed.

The transparent panel part 6 is preferably designed in a thermally insulating manner. For this purpose it can either be produced from a thermally insulating material or have an air gap 32.

In the embodiment depicted in FIG. 5.1 the reaction channels 4 are formed in the lower panel part 28. In addition to the semicircular cross-section depicted in this figure, the reaction channels 4 can also have a triangular, square, trapezoidal or any other desired cross-section known to the skilled man.

The reaction channels 4 are preferably sealed by the transparent top panel part 6. For this purpose the transparent top panel part 6 is preferably attached positively or non-positively to the lower panel part 28. In contrast to the embodiment in FIG. 5.1, the reaction channels 4 in FIG. 5.2 are also formed in the transparent top panel part 6. Due to the fact that the reaction channels 4 formed in the lower panel part 28 and the transparent top panel part 6 are superimposed congruently upon one another a circular cross-section of the reaction channels 4 can be produced. By avoiding corners in the reaction channels 4 the deposition of substances from the reaction medium on the channel walls 30, 31 is advantageously avoided.

### LIST OF REFERENCE NUMERALS

1 Microphotoreactor

2 Reaction zone panel

3 Housing

4 Reaction channel

5 Screw

6 Transparent top panel part

7 Inlet

8 Outlet

9 Irradiation source

10 Direction of the light rays

11 Electrical connection

12 Inlet opening

13 Collection zone

14 Outlet

15 Structure

16 Opening

17 Inlet opening for the first fluid

18 Inlet opening for the second fluid

19 Direction of flow

20 Mixing zone

21 Heat transfer module

22 Heating element

23 Inlet for a tempering medium

24 Outlet for a tempering medium

25 Gap

26 Tempering region

27 Temperature sensor

28 Lower panel part

29 Outlet openings

30 First channel wall

31 Second channel wall

1. A microphotoreactor for carrying out photochemical reactions in at least one reaction medium which is liquid, gaseous or a dispersion, in which the light required for carrying out the reaction is supplied by an irradiation source (9) arranged outside the reactor, wherein the reaction medium flows through at least one reaction channel (4) of a reaction zone (2), and wherein at least one region in this zone is transparent for the light and the direction of flow is inclined towards the horizontal at an angle of 10° to 90° in such a manner that the reaction medium is conveyed counter-gravitationally in the at least one reaction channel (4) by a pressure difference.

2. A microphotoreactor according to claim 1, wherein the reaction zone is designed in the form of a reaction zone panel (2).

3. A microphotoreactor according to claim 2, wherein the reaction zone panel (2) is fixed detachably to a heat transfer module (21).

4. A microphotoreactor according to claim 2, wherein the reaction zone panel (2) is designed in a flat, curved or cylindrical shape.

5. A microphotoreactor according to claim 2, wherein the reaction zone panel (2) comprises at least one lower panel part (28) and a transparent top panel part (6) which rests in a flush manner on the lower panel part (28) and is attached positively or non-positively thereto.

6. A microphotoreactor according to claim 5, wherein the at least one reaction channel (4) is accommodated in the lower panel part (28).

7. A microphotoreactor according to claim 5, wherein the at least one reaction channel (4) is accommodated in the transparent top panel part (6).

8. A microphotoreactor according to claim 5, wherein the lower panel part (28) is produced from a material which has high reflectivity in the spectral range of the radiation employed.

9. A microphotoreactor according to claim 5, wherein the lower panel part (28) is produced from a material which has catalytic activity.

10. A microphotoreactor according to claim 1, wherein the at least one reaction channel (4) is coated with a material having high reflectivity in the spectral range or with a catalytically active material.

11. A microphotoreactor according to claim 5, wherein the transparent top panel part (6) is produced from a thermally insulating material.

12. A microphotoreactor according to claim 5, wherein the transparent top panel part (6) acts as a spectral filter.

13. A microphotoreactor according to claim 3, wherein the heat transfer module (21) comprises electrical heating elements or Peltier elements for tempering the reaction zone panel (2) or is designed as a heat exchanger.

14. A microphotoreactor according to claim 3, wherein the heat transfer module (21) is designed in such a manner that a temperature gradient can be adjusted along the reaction zone panel (2) in the direction of flow.

15. A microphotoreactor according to claim 3, wherein sensors (27) for monitoring the reaction medium and for regulating reaction parameters are accommodated in the heat transfer module (21).

16. A microphotoreactor according to claim 1, wherein a mixing zone (20) is accommodated in the at least one reaction channel (4) for mixing at least two reaction media.

17. A microphotoreactor according to claim 16, wherein the mixing zone (20) is capable of being irradiated.

18. A microphotoreactor according to claim 16, wherein the irradiation with light is carried out directly following the mixing zone (20).

19. A microphotoreactor according to claim 1, wherein the at least one reaction channel (4) is coated with a material which influences the surface tension of the reaction medium.

20. A microphotoreactor according to claim 5, wherein the at least one reaction channel (4) is accommodated in both the lower panel part (28) and the transparent top panel part (6).

21. A microphotoreactor according to claim 5, wherein sensors (27) for monitoring the reaction medium and for regulating reaction parameters are accommodated in the lower panel part (28).
